(19) United States
(12) Patent Application Publication
(10) Pub. No.: US 2005/0087056 A1
(43) Pub. Date: Apr. 28, 2005

(54) Methods and devices for altering string spacing and tunings of a stringed instrument

(76) Inventors: Dennis Zager JR., Lincoln, NE (US); Dennis Zager SR., Lincoln, NE (US)

Correspondence Address: Mintz, Levin, Cohn, Ferris,;Glovsky and Popeo, P.C., The Chrysler Center, 666 Third Avenue, 24th Floor, New York, NY, 10017, US

(21) Appl. No.: 10/977,875

(22) Filed: Oct. 28, 2004

Related U.S. Application Data
(60) Provisional application No. 60/515,321, filed on Oct. 28, 2003.

(51) Int. Cl. G10D 3/00; G10D 3/16

(52) U.S. Cl. 84/318

(57) ABSTRACT

A musical instrument string spacing device is provided and may include a first member for interaction with one or more strings positioned on a top surface of a neck of a musical instrument. The first member may include a plurality of sides, where each side may include a plurality of recesses arranged in a respective predetermined spaced apart relationship, and where each recess may be used for receiving a respective string of the musical instrument. Each of the sides of the first member may be positioned to interact with one or more strings of the musical instrument. The string spacing device may also include a second member in a compressive arrangement with the first member, where the second member engages a lower surface of the neck of the musical instrument.

This application claims benefit under 35 U.S.C. § 119(e) of U.S. Provisional Application No. 60/515,321, filed Oct. 28, 2003, the entire disclosure of which is herein incorporated by reference.

### BACKGROUND OF THE INVENTION

1. Field of the Invention

The present invention relates to guitar string clamps and more particularly pertains to a new capo device (or string spacing device) for a stringed instrument for clamping strings to the fingerboard of a stringed instrument and modifying string spacings and/or alternate tunings quickly and effectively.

2. Background

The use of guitar string clamps is known in the prior art. More specifically, known guitar string clamps generally consist of familiar, expected and obvious structural configurations, notwithstanding the myriad of designs encompassed by the prior art which have been developed for the fulfillment of countless objectives and requirements.

While these known devices fulfill their respective, particular objectives and requirements, such devices have not addressed the problem of changing string spacings of a guitar (for example), in a quick and efficient manner, nor have the known devices offered the ability for a player to change tunings in a quick and efficient manner.

### SUMMARY OF THE INVENTION

Embodiments of the present invention address the problems with the prior art and present a string spacing/capo device which allows musicians to easily change tunings as well as establish alternate spacings of the strings across the width of the guitar neck to take advantage of the full width of the guitar fretboard (for example).

Accordingly, in one embodiment of the present invention, a musical instrument string spacing device, is provided and may include a first member for interaction with one or more strings positioned on a top surface of a neck of a musical instrument. The first member may include a plurality of sides, where each side may include a plurality of recesses arranged in a respective predetermined spaced apart relationship, and where each recess may be used for receiving a respective string of the musical instrument. Each of the sides of the first member may be positioned to interact with one or more strings of the musical instrument. The string spacing device may also include a second member in a compressive arrangement with the first member, where the second member engages a lower surface of the neck of the musical instrument.

The string spacing member may also be in the form of a capo device.

Such embodiments may also include a lateral member connecting the first member and the second member, where at least one of the first member and second member are pivotable relative to the lateral member, and may also include compression means for producing compression between the first member and the second member. Such compression means may include, for example, a spring and/or a locking arm. The locking arm may include an adjustable set screw for engagement with the second member, and may also be pivotable relative to at least one of the lateral member, the first member and the second member.

The first member may include a structural support arm and a string engagement member having the plurality of sides. The string engagement member may be alternately positioned relative the structural support arm so that each side positioned for engaging one or more strings of the musical instrument. Moreover, the string engagement member may be rotatable relative to the structural support arm.

In another embodiment, a method for spacing strings apart across the neck of a guitar is disclosed and may include providing a first member for interaction with one or more strings positioned on a top surface of a neck of a guitar, the first member including a plurality of sides, where each side including a plurality of recesses arranged in a respective predetermined spaced apart relationship and each recess receives a respective string of the guitar, and a second member in a compressive arrangement with the first member, the second member for engagement with a lower surface of the neck. The method may also include engaging one or more strings with respective recesses in a side of the first member and compressing the one or more strings of the guitar toward the fretboard of the guitar behind a fret.

### BRIEF DESCRIPTION OF THE DRAWINGS

FIG. 1 is a front view of a capo device according to an embodiment of the present invention.

FIG. 2 is a perspective view of a string spacing mechanism according to an embodiment of the present invention which may be used with a capo device.

FIG. 3 is a perspective view of a string spacing mechanism according to another embodiment of the present invention which may be used with a capo device.

FIG. 4 is a schematic view of a string spacing member positioned on a guitar neck, according to embodiments of the present invention.

### DETAILED DESCRIPTION OF THE EMBODIMENTS

Accordingly, embodiments of the present invention address at least the problems pointed out in the background section of the present application, and present a new capo device for a stringed instrument which departs from the conventional concepts and designs of the prior art. Specifically, the embodiments of the present invention present a capo which allows players to quickly and efficiently change the spacings of strings on a guitar (for example) and/or change the tuning of the guitar (e.g., drop D, open D, open G, etc.).

Features of some of the embodiments may be used with any capo device, and used along with other features of such devices. For example, features of the present invention may be used with devices disclosed in U.S. Pat. Nos. 3,823,247 (Bauerfeind), 5,623,110 (Hoglund et al.), 4,104,947 (Oster), 4,250,790 (Shubb), 4,793,234 (Geis), and 6,573,440 (Rodriguez), each disclose of which, in its entirety, is herein incorporated by reference.

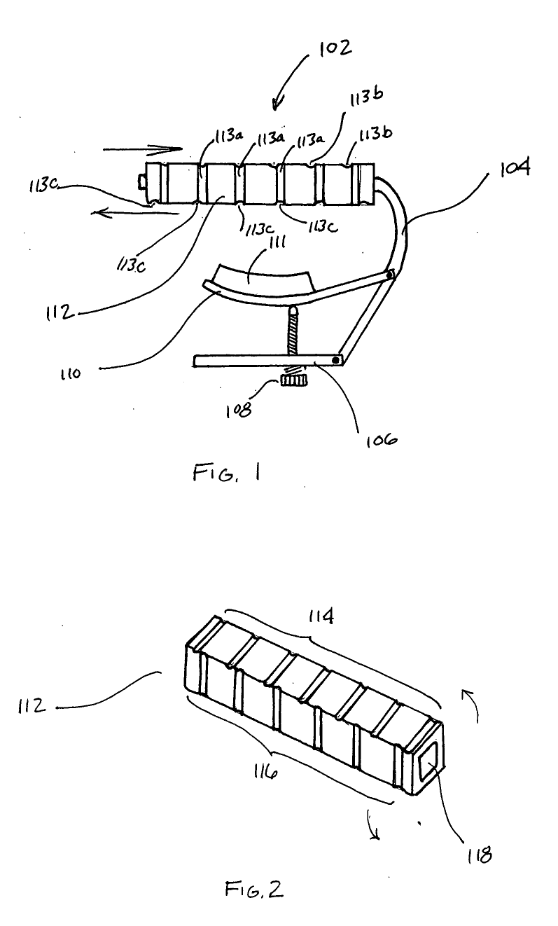

Some embodiments of the invention are illustrated in FIGS. 1-4. As shown, capo device 102 includes structural member 104, under the neck gripping member 110 having a non-slip gripping portion 111, clamping adjustment member 106 having adjustment set-screw 108 (which may include a tensioning spring), and string spacing/tuning interaction member 112. Structural member 104 may include a curve so that it more easily interacts with say, for example, a fretboard of a guitar which typically is slightly curved.

More specifically with regard to member 112, this member is preferably a multi-sided object (preferably two or more sides for interaction with the strings of the instrument). The illustrated embodiments may include four independent sides, with each side having the ability to include a series of specific notch/groove patterns for respective strings for gripping respective strings and spacing them apart from one another according to a predetermined arrangement (or clamping some strings down while allowing others to freely vibrate in an open position). Accordingly, when a respective notch of member 112 receives a respective string, the depth of the notch is formed such that not only is the string moved to a new position upon interaction with the string, but an adequate amount of downward pressure is supplied to the string from member 112, via the clamping force of the other members of the capo, that respective strings are contacted with a chosen fret on the neck of the stringed instrument. This allows the string to be held steadfast in its new position. Thus, each notch provides an adequate amount of shoulder area (left and/or right) to interact with a respective string to move it to a new position and retain it in the new position.

As shown in FIG. 1, member 112 may include multiple string spacing arrangements on respective sides. For example, member 112 may include a first set of string spacings and or tunings 113a, a second set 113b, a third set 113c and a fourth set (not shown).

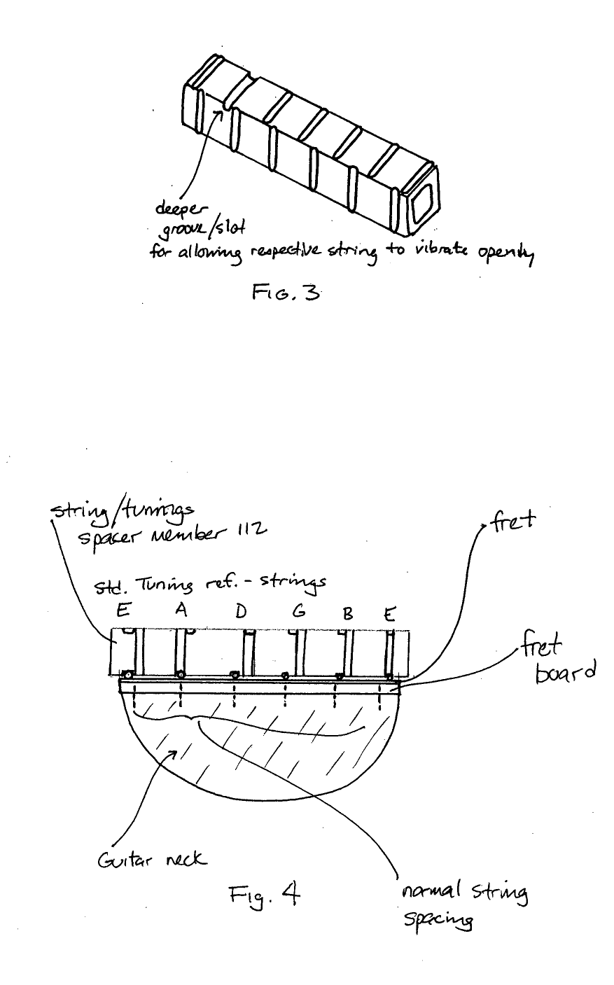

As shown in FIG. 3, an alternative tuning may be arranged on a side of the member 112 by providing a deeper (and/or wider) slot for a specific string(s), so that upon use of the capo, the specific slot(s) does not interact with the respective string(s). Thus, an alternate tuning (relative to standard or any other tuning of the stringed instrument in an open—uncapoed—position) is produced. Accordingly, any number of alternate tunings may be produced with such an embodiment by providing specific notches for respective strings which let some strings be clamped by the capo and other notches to let a corresponding string vibrate freely by not interacting at all with the respective notch or member 112 (e.g., open tunings, drop D, etc.).

As an example of an embodiment of the invention showing how the member 112 interacts with the strings is illustrated in FIG. 4. As shown, the low E, B and high E strings of a six (6) string guitar are moved to new positions, relative to their original positions (shown in dashed lines in the figure). As also shown in the figure, one set of spacings interacts with the strings, as other sets of spacings, front, top and rear (not shown) are not used.

Accordingly, in order to use the alternate spacings, the player simply removes the capo (e.g., relief of clamping pressure) and moves the member 112 to a new position so that a new set of spacings face the guitar strings. The capo is then clamped back on the neck of the instrument which is then ready to play.

Member 112 may be manufactured in a manner which allows it to easily pivot, relative to structural member 104, to a new position, so that a particular side of member 112 faces the strings. Accordingly, the spacer/tuning member may be made of any material that is resilient enough to be used many times over, not damage the strings or instrument, and hold the strings effectively. Accordingly, such materials may be rubber, wood, plastic, natural and synthetic materials.

In addition, each side of member 112 may include a number or letter or other symbol, to that a user can easily distinguish between the spacings. Moreover, such a symbol system may be an ascending/descending type of system, in that a higher number or letter, or larger symbol, may be used for larger/bigger string spacings.

The spacer/tuning member may also be mounted to the structural member of the capo, such that is may be easily rotated relative thereto. Accordingly, such an embodiment may include a hub/wheel device with or without bearings to provide for a smooth rotation. Alternatively, one embodiment is simply directed to a spacer/tuning member 112 made of, for example, rubber, having opening 118 (FIG. 2) for receiving structural member 104, which can be easily pulled off structural member 104, and/or turned, so that a particular side of member 112 faces the strings having the desired one or more recesses positioned in a predetermined spaced arrangement with one another.

The spacer/tuning member may be shaped in the form of any multi-faceted shape including, for example, square, pentagonal, hexagonal, octagonal, etc. Moreover, member 112 may be round, and the recesses helical around member 112, so that an infinite number of string spacings may be selected by a player of the guitar. Further yet, a plurality of different members 112, each having a particular number of tunings and/or spacings, may be provided, so that a player can replace one member 112 with another, thereby increasing the utility of the device.

Having now described a few embodiments of the invention, it should be apparent to those skilled in the art that the foregoing is merely illustrative and not limiting, having been presented by way of example only. All embodiments may be structured for use on any current or future capo device. Numerous modifications and other embodiments are within the scope of ordinary skill in the art and are contemplated as falling within the scope of the invention.

1. A musical instrument string spacing device comprising:
a first member for interaction with one or more strings positioned on a top surface of a neck of a musical instrument, the first member including a plurality of sides, wherein each side including a plurality of recesses arranged in a respective predetermined spaced apart relationship, and where each recess for receiving a respective string of the musical instrument;
a second member in a compressive arrangement with the first member, the second member for engagement with a lower surface of the neck.

2. The musical instrument string spacing device according to claim 1, further comprising a lateral member connecting the first member and the second member, wherein at least one of the first member and second member are pivotable relative to the lateral member.

3. The musical instrument string spacing device according to claim 1, further comprising compression means for producing compression between the first member and the second member.

4. The musical instrument string spacing device according to claim 3, wherein the compression means comprises a spring.

5. The musical instrument string spacing device according to claim 3, wherein the compression means comprises a locking arm, wherein the locking arm for includes an adjustable set screw for engagement with the second member.

6. The musical instrument string spacing device according to claim 5, wherein the locking arm is pivotable relative to at least one of the lateral member, the first member and the second member.

7. The musical instrument string spacing device according to claim 1, wherein each of the side of the first member may be positioned to interact with one or more strings of the musical instrument.

8. The musical instrument string spacing device according to claim 1, wherein the first member comprises a structural support arm and a string engagement member having the plurality of sides.

9. The musical instrument string spacing device according to claim 8, wherein the string engagement member may be alternately positioned relative the structural support arm so that each side positioned for engaging one or more strings of the musical instrument.

10. The musical instrument string spacing device according to claim 8, wherein the string engagement member is rotatable relative to the structural support arm.

11. A musical instrument string spacing device comprising:
a first member for interaction with one or more strings positioned on a top surface of a neck of a musical instrument, the first member including a plurality of sides, wherein:
each side including a plurality of recesses arranged in a respective predetermined spaced apart relationship, and wherein each recess for receiving a respective string of the musical instrument,
the first member comprises a structural support arm and a string engagement member having the plurality of sides, and
the string engagement member may be alternately positioned relative the structural support arm so that each side may be positioned for engaging one or more strings of the musical instrument;
a second member in a compressive arrangement with the first member, the second member for engagement with a lower surface of the neck.
a lateral member connecting the first member and the second member, wherein at least one of the first member and second member are pivotable relative to the lateral member; and
compression means for producing compression between the first member and the second member.

12. A capo for a guitar comprising:
a first member for interaction with one or more strings positioned on a top surface of a neck of a guitar, the first member including a plurality of sides, wherein each side including a plurality of recesses arranged in a respective predetermined spaced apart relationship, and where each recess for receiving a respective string of the guitar;
a second member in a compressive arrangement with the first member, the second member for engagement with a lower surface of the neck.

13. The capo according to claim 12, further comprising a lateral member connecting the first member and the second member, wherein at least one of the first member and second member are pivotable relative to the lateral member.

14. The capo according to claim 12, further comprising compression means for producing compression between the first member and the second member.

15. The capo according to claim 14, wherein the compression means comprises a spring.

16. The capo according to claim 14, wherein the compression means comprises a locking arm, wherein the locking arm for includes an adjustable set screw for engagement with the second member.

17. The capo according to claim 16, wherein the locking arm is pivotable relative to at least one of the lateral member, the first member and the second member.

18. The capo according to claim 12, wherein each of the side of the first member may be positioned to interact with one or more strings of the guitar.

19. The capo according to claim 12, wherein the first member comprises a structural support arm and a string engagement member having the plurality of sides.

20. The capo according to claim 19, wherein the string engagement member may be alternately positioned relative the structural support arm so that each side positioned for engaging one or more strings of the guitar.

21. The capo according to claim 19, wherein the string engagement member is rotatable relative to the structural support arm.

22. A method for spacing strings apart across the neck of a guitar comprising:
providing:
a first member for interaction with one or more strings positioned on a top surface of a neck of a guitar, the first member including a plurality of sides, wherein each side including a plurality of recesses arranged in a respective predetermined spaced apart relationship, and wherein each recess for receiving a respective string of the guitar; and
a second member in a compressive arrangement with the first member, the second member for engagement with a lower surface of the neck;
engaging one or more strings with respective recesses in a side of the first member;
compressing the one or more strings of the guitar toward the fretboard of the guitar behind a fret.
